(19) United States
(12) Patent Application Publication
(10) Pub. No.: US 2021/0317299 A1
(43) Pub. Date: Oct. 14, 2021

(54) AMORPHOUS COPOLYMERIZED POLYESTER RAW MATERIAL FOR A FILM, HEAT-SHRINKABLE POLYESTER-BASED FILM, HEAT-SHRINKABLE LABEL, AND PACKAGING BAG

(71) Applicant: TOYOBO CO., LTD., Osaka (JP)

(72) Inventors: Masafumi INOUE, Tsuruga (JP); Masayuki HARUTA, Tsuruga (JP)

(73) Assignee: TOYOBO CO., LTD., Osaka (JP)

(21) Appl. No.: 17/263,838

(22) PCT Filed: Jul. 26, 2019
(86) PCT No.: PCT/JP2019/029393

§ 371 Date: Jan. 27, 2021

(30) Foreign Application Priority Data
Aug. 3, 2018 (JP) 2018-146980

(51) Int. Cl. C08L 67/02; C08G 63/672; B65D 75/00; B65D 65/04; C08G 63/183; B29C 61/02

(52) U.S. Cl. CPC C08L 67/025; C08G 63/672; B65D 75/002; B29K 2067/003; C08G 63/183; B29C 61/02; C08L 2203/16; B65D 65/04

(57) ABSTRACT

The invention provides an amorphous copolymerized polyester raw material for a film, wherein the copolymerized polyester raw material (1) contains ethylene terephthalate as a main constituent component, and neopentyl glycol by 15-30 mol % when a total amount of glycol component in a total polyester resin component is taken as 100 mol %, (2) contains a constituent unit derived from diethylene glycol by 7-15 mol % in the total amount of glycol component 100 mol % in the total polyester resin component, (3) has an intrinsic viscosity of 0.60 dl/g or more and less than 0.70 dl/g, and (4) has a glass transition temperature of 60-70° C. The invention also provides a heat-shrinkable polyester-based film containing the amorphous copolymerized polyester raw material, as well as a heat-shrinkable label and a packaging bag.

### TECHNICAL FIELD

The present invention relates to a heat-shrinkable polyester based film suitable for a heat-shrinkable label, a production thereof, and a raw material for a film.

### BACKGROUND ART

Recently, in applications such as label package doubling as protection of glass bottles, plastic bottles, or the like and as display of articles, cap sealing and accumulation package. there has been widely used, as a shrinkable label, a polyester based heat-shrinkable film that is high in heat resistance, easy to incinerate, and excellent in solvent resistance. The use amount of the polyester-based heat-shrinkable film tends to increase being accompanied by an increase in volume of PET (polyethylene terephthalate) bottle containers and the like.

Heretofore, a heat-shrinkable polyester based film has been widely utilized which shrinks greatly in the width direction. It is also known that a shrinkage ratio in the longitudinal direction, which is a non-shrinking direction, is made to be below zero (so-called extend due to heating) in order to achieve satisfactory shrinkage finishing properties (Patent Literature 1).

As shortcomings of a heat-shrinkable film with a high shrinkage ratio so as to be adaptable to use in various containers, there are problems that a natural shrinkage ratio and that a hot water shrinkage ratio measured at 70° C. lowers after storage at an ordinary temperature (after an aging treatment) becomes high (Patent Literatures 2 and 3). Patent Literature 2 tries to adopt a production method wherein the film is subjected to a biaxial stretch and discloses that, a natural shrinkage ratio is improved by strengthening by cooling after biaxial orientation and lengthwise stretching. However, Patent Literature 2 does not disclose hot-water heat shrinkage ratios measured at 70° C. before and after the aging treatment. In Patent Literature 3, although a natural shrinkage ratio Is improved, technical findings concerning the improvement in the natural shrinkage ratio are not disclosed. In addition, values of the shrinkage ratios at 70° C. before and after the aging treatment are not disclosed. When a decrease in a shrinkage ratio at 70° C. is large, initial shrinkage ratios in shrinking the film are different before and after the aging treatment, whereby the shrinkage finishing properties become bad. In a shrinkage apparatus using a hot air having low heat transfer coefficient in particular, if the initial shrinkage ratios by hot air are different, shrinkage upon finishing may be insufficient and strain of label may result.

A film that heat-shrinks in the longitudinal direction as described in Patent Literature 4 is generally stretched between rolls using a speed difference between heated rolls, and thus a deformation speed of the film during stretching is faster than that of a film that shrinks in the width direction. It is not preferable if the deformation speed during stretching is fast, since a necking force is generated in a direction orthogonal to a stretching direction (non shrinking direction) during stretching, and a heat-shrinkage ratio in the non shrinking direction also becomes high. Therefore, it is import ant to suppress the necking force. High temperature stretching is known as a means for suppressing the necking force. However, if a film stretching stress is reduced by high-temperature stretching (the necking force is suppressed), a molecular orientation in the stretching direction is also reduced whereby a heat-shrinkage ratio in a main shrinkage direction may be reduced, and in addition, the irregularity of thickness may increase.

Furthermore, if the interval between the rolls is increased so as to slow-down the deformation speed during stretching, neck-in occurs in the film, resulting in significant difference in the characteristics in the width direction of the film after stretching, and therefore this is not preferable.

A polyester raw material that can improve the above-mentioned shortcomings has not been found.

### CITATION LIST

### Patent Literature

Patent Literature 1: JP H05-33895 B
Patent Literature 2: JP 4411558 B
Patent Literature 3: JP 5249987 B
Patent Literature 4: JP 2011-79229 A

### SUMMARY OF THE INVENTION

### Problems to be Solved by the Invention

The present invention aims to provide a heat-shrinkable polyester-based film having a high heat-shrinkage ratio in the main shrinkage direction, a low natural shrinkage ratio and a change of a shrinkage ratio after an aging treatment, a low shrinkage stress, and a small irregularity of thickness. Further, the present invention also aims to provide a raw material to produce the heat-shrinkable polyester-based film.

### Solution to the Problems

The constitutions of the present invention which can solve the above problems are as follows.
1. An amorphous copolymerized polyester raw material for a film, wherein
   the polyester raw material satisfies the following requirements (1) to (4):
      (1) the copolymerized polyester raw material contains an ethylene terephthalate as a main component, and comprises a neopentyl glycol by 15 mol % or more and 30 mol % or less when a total amount of glycol component in a total polyester resin component is taken as 100 mol %,
      (2) the copolymerized polyester raw material comprises a constituent unit derived from diethylene glycol by 7 mol % or more and 15 mol % or less in the total amount of glycol component 100 mol % in the total polyester resin component.
      (3) the copolymerized polyester raw material has an intrinsic viscosity of 0.60 dl/g or more and less than 0.70 dl/g, and
      (4) the copolymerized polyester raw material has a glass transition temperature of 60° C. or higher and 70° C. or lower.
2. The copolymerized polyester raw material for a film according to the above 1, wherein when the copolymerized polyester raw material is made into a film having a thickness of 30 μm, a number of defects in 1 mm size or more in the longitudinal direction of the film or in the width direction of the film is 1.5 or less on an average per 10 square meters of the film.
3. The copolymerized polyester raw material for a film according to the above 1 or 2, wherein the copolymerized polyester raw material has a melt viscosity of 180 Pa·S or less measured at a shear rate of 6080/S at 250° C., and a melt viscosity of 350 Pa·S or less measured at a shear rate of 6080/S at 230° C.
4. A heat-shrinkable polyester-based film, wherein
   the heat-shrinkable polyester-based film comprises the amorphous copolymerized polyester raw material according to any one of the above 1 to 3, and satisfies the following requirements (1) to (5):
      (1) intrinsic viscosity is 0.57 dl/g or more and 0.67 dl/g or less.
      (2) a hot-water heat-shrinkage ratio measured by immersing the film for 10 seconds in 90° C. hot water is 55% or more and 85% or less in a main shrinkage direction of the film.
      (3) a hot-water heat shrinkage ratio measured by immersing the film for 10 seconds in 80° C. hot water is −10% or more and 1% or less m an orthogonal direction to the main shrinkage direction of the film,
      (4) a maximum shrinkage stress measured under 90° C. hot air is 2 MPa or more and 7 MPa or less in the main shrinkage direction of the film,
      (5) a difference of a hot water beat shrinkage ratio measured by immersing the film for 10 seconds in 70° C. hot water in the main shrinkage direction of the film is 0% or more and 5% or less between the film after being subjected to an aging treatment for 672 hours at 30° C. and a relative humidity of 65% and the film before being subjected to the aging treatment.
5. The heat-shrinkable polyester-based film according to the above 4, wherein an irregularity of thickness per 1 m length is 10% or less both in the longitudinal direction of the film and in the width direction of the film.
6. A heat-shrinkable label, comprising the heat-shrinkable polyester-based film according to the above 4 or 5.
7. A packaging bag, wherein the packaging bag is produced by covering at least a part of a periphery of an object for packaging with the heat-shrinkable label according to the above 6, and followed by subjecting to a heat-shrinking treatment.

### Advantageous Effects of the Invention

The heat-shrinkable polyester-based film of the present invention not only has a high shrinkage ratio, but also has a small decrease in the shrinkage ratio measured at 70° C. after an aging treatment. Therefore, the films before and after the aging treatment can continuously and industrially-stably shrink under the some shrinkage condition.

The raw material of the present invention has a low melt viscosity at 230° C. of the resin temperature because of its low intrinsic viscosity. Therefore, the raw material may be extruded at a lower temperature than commonly used polyester row materials. The raw material comprises a lot of diethylene glycol such that a constituent unit derived from diethylene glycol is 7 mol % or more and 15 mol % or less in the total amount of glycol component 100 mol %. Nevertheless, when the raw material is made into a film having a thickness of 30 μm, it is possible to decrease a number of defects in 1 mm size or more in the longitudinal direction of the film or in the width direction of the film to 1.5 or less on an average per 10 square meters of the film.

The heat-shrinkable polyester-based film of the present invention has not only a high shrinkage ratio, but also a low shrinkage stress and a small irregularity of thickness. Thus, the film is also suitable for a thin-walled container, and thus the heat-shrinkable film that can wrap a wider range of the objects than before is provided.

Further, the heat-shrinkable polyester-based film of the present invention includes not only a single-layer heat-shrinkable polyester-based film but also a laminate heat-shrinkable film with the heat-shrinkable polyester-based film of the present invention and a different resin layer.

Additionally, a packaging covered with the label produced by the heat-shrinkable polyester-based film of the present invention has a beautiful appearance.

### DESCRIPTION OF EMBODIMENTS

Hereinafter, the heat-shrinkable polyester based film of the present invention will be explained in detail. The method for producing the heat-shrinkable polyester-based film will be explained in detail later. The heat-shrinkable film is usually produced by unwinding and stretching a roll or the like. At this time, the direction in which the film is unwound is determined as a longitudinal direction, and the direction orthogonal to the longitudinal direction is determined as a width direction of the film. Therefore, the width direction of the heat shrinkable polyester-based film as shown below means a direction orthogonal to a direction of unwinding the roll, and the longitudinal direction of the film means a direction parallel to the direction of unwinding the roll.

One of the methods for producing a film with higher shrinkage is to increase an amount of a monomer component constituting a unit that can form an amorphous component in the film (hereinafter, simply called as “amorphous component”). In the film produced by a conventional transversely uniaxially stretching method, a shrinkage ratio was found to be increased corresponding with an increase of the amount of the amorphous component. However, although the film could be made to shrink highly by simply increasing the amount of the amorphous component, it was found that an aging treatment caused problems such as an increase in the natural shrinkage ratio, and a decrease in the shrinkage ratio measured at a low temperature of about 70° C. Additionally, it was found that the increase of the amount of the amorphous component deteriorated an irregularity of thickness and an appearance of the film product roll. Therefore, the present inventors focused on the diethylene glycol (hereinafter, simply called as “DEG”).

When the amount of diethylene glycol increases, heat resistance wall deteriorate, and an amount of the extruded defects will increase when melt-extruding. Thus, the diethylene glycol has not been actively used in the past. However, the present inventors found that a stretching stress when stretching the film would decrease, and further a decrease in the shrinkage ratio measured at a low temperature of about 70° C. after the aging treatment would be suppressed by selecting diethylene glycol as a constituent unit of the polyester resin.

An amorphous copolymerized polyester used for producing the heat-shrinkable polyester-based film of the present invention contains an ethylene terephthalate unit as a main component. The phrase “containing as a main component” refers to comprising 50 mol % or more of the ethylene terephthalate in the whole amount of constituent components. The content of the ethylene terephthalate unit is preferably 50 mol % or more, more preferably 60 mol % or more, and further preferably 70 mol % or more in a constituent component of the polyester 100 mol %.

Examples of other dicarboxylic acid components other than terephthalic acid constituting the polyester of the present invention may include aromatic dicarboxylic acids such as isophthalic acid, orthophthalic acid and 2,6-naphthalendicarboxylic acid; aliphatic dicarboxylic acids such as adipic acid, azelaic acid, sebacic acid, and decanedicarboxylic acid; and alicyclic dicarboxylic acids such as 1,4-cyclohexanedicarboxylic acid. The content of the terephthalic mud component is preferably 80 mol % or more, more preferably 85 mol % or more, further preferably 90 mol % or more, and more further preferably 95 mol % or more in a polyol component 100 mol % and a polycarboxylic acid component 100 mol % (in other words, total 200 mol %) in whole amount of the polyester resin. In the present invention, it is most preferable that the polyester resin does not contain other dicarboxylic acid components other than terephthalic acid (in other words, terephthalic acid 100 mol %).

Here, an interpretation of the term “that can form an amorphous component” will be explained in detail.

In the present invention, the “amorphous polymer” specifically riders to the case where no endothermic peak due to fusion is shown in measurement with a differential scanning calorimeter (DSC). Since the crystallization of the amorphous polymer does not substantially proceed, the amorphous polymer cannot be in a crystalline state or has an extremely low degree of crystallinity even when crystallized.

Furthermore, in the present invention, the “crystalline polymer” refers to a polymer other than the above-mentioned “amorphous polymer”, that is, the case where an endothermic peak due to fusion is shown in measurement with a differential scanning calorimeter (DSC). The crystalline polymer means a polymer that can be crystallized when heated, has a crystallizable property, or has been already crystallized.

In general, as for a polymer being in a state where a plurality of monomer units are bonded, when the polymer has various conditions such as low stereoregularity of a polymer, poor symmetry of a polymer, a large side chain of a polymer, a large number of branches of a polymer, and low intermolecular cohesion between polymers, the polymer becomes amorphous. However, depending on the existence state, the crystallization sufficiently proceeds, and the polymer may become crystalline polymer. For example, even for a polymer having a large side chain, when the polymer is composed of a single monomer unit, the crystallization of the polymer may sufficiently proceed, and the polymer may become crystalline. For this reason, even if the polymer is composed of the same monomer unit, the polymer can become crystalline or ran become amorphous. Therefore, in the present invention, the expression “unit derived from a monomer that can form an amorphous component” is used.

The monomer unit in the present invention means a repeating unit constituting a polymer induced from one polyol molecule and one polycarboxylic acid molecule.

In case where a monomer unit consisting of terephthalic acid and ethylene glycol (ethylene terephthalate unit) is the main monomer unit that constituting the polymer, the unit derived from a monomer that can form an amorphous component is exemplified by a monomer unit consisting of isophthalic acid and ethylene glycol; a monomer unit consisting of terephthalic acid and neopentyl glycol; a monomer unit consisting of terephthalic acid and 1,4-cyclohexanedimethanol; and a monomer unit consisting of isophthalic acid and butanediol.

Further, the polyester does not contain a polycarboxylic acid having 3 or more valence (for example, trimellitic acid, pyromellitic acid and anhydrides thereof), preferably. The heat-shrinkable polyester-based films produced by using the polyester containing these polycarboxylic acids are less likely to have a required high shrinkage ratio.

Examples of a diol component constituting the polyester of the present invention other than the ethylene terephthalate unit include aliphatic diols such as 1,3-propanediol, 2,2-diethyl-1,3-propanediol, 2-n-butyl-2-ethyl-1,3-propanediol, 2,2-isopropyl-1,3-propanediol, 2,2-di-n-butyl-1,3-propanediol, 1,4-butanediol, hexanediol, neopentyl glycol, and hexanediol; alicyclic diols such as 1,4-cyclohexanedimethanol; and aromatic diols such as bisphenol A.

The amorphous copolymerized polyester for producing the heat-shrinkable polyester-based film of the present invention needs to contain a constituent unit derived from diethylene glycol. The copolymerized polyester raw material comprises the constituent unit derived from diethylene glycol by preferably 7 mol % or more, more preferably 8 mol % or more, further preferably 0 mol % or more, and more further preferably 10 mol % or more in the constituent unit 100 mol % of the polyester. The upper limit of the constituent unit derived from diethylene glycol is preferably 15 mol % or less, more preferably 14 mol % or less, and further preferably 13 mol % or less. A constituent unit derived from diethylene glycol is preferable since it is a component that lowers a glass transition temperature of the polyester and increases a heat-shrinkage ratio of the heat-shrinkable polyester-based film measured at a low temperature. Additionally, it is preferable if the raw material comprises a constituent unit derived from diethylene glycol by 7 mol % or more, since the effects of the present invention such as a decrease in the shrinkage ratio measured at 70° C. after the aging treatment or a decrease in the shrinkage stress would be improved. Contrarily, it is not preferable if the raw material comprises a diethylene glycol component by more than 15 mol %, since the effect of improving a decrease in the shrinkage ratio measured at 70° C. after the aging treatment would be small, and the deterioration and the defects would increase in the film.

Further, the polyester may comprise a sum of the amorphous component by 15 mol % or more, preferably 16 mol % or more, and more preferably 17 mol % or more in a polyol component 100 mol % and a polycarboxylic acid component 100 mol % (in other words, total 200 mol %) in whole amount of the polyester resin. The upper limit of the sum of the amorphous component may be 30 mol % or less, preferably 29 mol % or less, and more preferably 28 mol % or less. By controlling an amount of the constituent unit derived from diethylene glycol or the amorphous component within the above range, the polyester having a glass transition temperature (Tg) adjusted to 60 to 70° C. may be obtained. If Tg is low, molecules in the film will move at room temperature, and the physical propertied of the film will change. Therefore, Tg is preferably 61° C. or higher, and more preferably 62° C. or higher. Contrarily, if Tg is high, the hot-water heat shrinkage ratio at 70° C. would be lower. Therefore, Tg is preferably 69° C. or lower, and more preferably 68° C. or lower.

The polyester does not comprise a diol having 8 or more carbon atoms (for example, ortanecliol, etc.), or a polyol having 3 or more valences (for example, trimethylolpropane, trimethylolethane, glycerin, diglycerin, etc.), preferably. The heat-shrinkable polyester-based film, which is made from the polyester comprising these diols or the polyol, is less likely to have a required high shrinkage ratio. Further, the polyester does not comprise triethylene glycol or polyethylene glycol as much as possible. Additionally, the polyester preferably has a copolymerized amorphous component in a polyol component 100 mol % and a polycarboxylic acid component 100 mol % (in other words, total 200 mol % in whole polyester resin. Copolymerization will eliminate a concern about segregation of the raw materials. Thereby, a change in physical properties of the film can be prevented due to fluctuation in the raw material composition of the film. Further, copolymerization will promote transesterification, and an amount of the amorphous component will increase. That will work in favor of increasing the shrinkage ratio in the main shrinkage direction.

If necessary, the resin constituting the heat-shrinkable polyester-based film of the present invention may contain various additives such as a wax, an antioxidant, an antistatic agent, a crystal nucleating agent, a viscosity reducing agent, a thermal stabilizer, a coloring pigment, an anti-coloring agent, and an ultraviolet absorber.

The resin constituting the heat-shrinkable polyester-based film of the present invention preferably contains fine particles as a lubricant for improving workability (slipperiness)) of the film. As the fine particles, those of an arbitrary substance may be used. Examples of inorganic fine particles may include silica, alumina, titanium dioxide, calcium carbonate, kaolin, barium sulfate. Examples of organic fine particles may include acrylic resin particles, melamine resin particles, silicone resin particles, cross-linked polystyrene particles. The average particle size of the fine particles may be appropriately selected within a range of 0.05 μm to 3.0 μm (when measured by Coulter counter) as needed.

In the case of silica, if the content is, for example, 50 ppm or more and 3000 ppm or less, the average particle size of the fine particles may be controlled within the above range. The content of silica is preferably 200 ppm or more, and more preferably 300 ppm or more. If the content of silica is too high, transparency may be impaired. Thus, for the film that requires transparency, the content of silica is preferably 2000 ppm or less, and more preferably 1500 ppm or less.

A method of blending the above fine particles in the resin constituting the heat-shrinkable polyester-based film is, for example, that the fine particles may can be added at an arbitrary stage in the production of the polyester-based resin. It is preferable that a slurry of the fine particles dispersed in ethylene glycol or the like can be added at a stage of esterification or at a stage after completion of ester exchange reaction and before start of polycondensation reaction, and then polycondensation reaction can be advanced. Further, a preferable blending method may also include a method in which a slurry of fine particles dispersed in ethylene glycol, water, or other solvent and raw materials of polyester-based resin are mixed using a kneading extruder with a vent, and a method in which dried fine particles and raw materials of polyester-based resin are mixed using a kneading extruder.

The heat-shrinkable polyester-based film of the present invention may be subjected to a corona treatment, a coating treatment, a flame treatment or the like for improving an adhesive property of a film surface.

Next, the characteristics of the amorphous copolymerized polyester raw material and the heat-shrinkable polyester-based film of the present invention will be described.

The amorphous copolymerized polyester raw material of the present invention preferably has an intrinsic viscosity of 0.6 dl/g or more and less than 0.7 dl/g. By controlling the intrinsic viscosity within the above range and combining with the melt-extruding condition descried later, the intrinsic viscosity of the heat-shrinkable polyester-based film can be controlled within 0.57 dl/g or more and 0.07 dl/g or less.

It is not preferable if the intrinsic viscosity of the heat-shrinkable polyester-based film falls under 0.57 dl/g, since the stretching in the process for producing the film would be difficult. Thus, the so-called “breakage” phenomenon would occur, and a productivity would deteriorate. The intrinsic viscosity of heat-shrinkable polyester based film is preferably 0.59 dl/g or more, and more preferably 0.61 dl/g or more. There is no problem if the intrinsic viscosity of the heat-shrinkable polyester-based film exceeds 0.67 dl/g. However, since the upper limit of the intrinsic viscosity of the raw material is 0.7 dl/g, the upper limit of the intrinsic viscosity of the film is set to 0.67 dl/g. By controlling the upper limit of the intrinsic viscosities of the amorphous copolymerized polyester raw material and the heat-shrinkable polyester-based film within the above range, as explained above, the stretching stress in the longitudinal direction could be decreased and the necking force in the direction orthogonal to the stretched direction could be suppressed, especially when producing the heat-shrinkable film with a longitudinal direction as a main shrinkage direction by stretching between rolls. Thereby, the film with a low shrinkage stress in the longitudinal direction and a small irregularity of thickness may be produced.

The amorphous copolymerized polyester raw material of the present invention preferably has a melt viscosity of 180 Pa·S or less measured at a shear rate of 6080/S at 250° C. Additionally, the raw material preferably has a melt, viscosity of 350 Pa·S or less measured at a shear rate of 6080/S at 230° C. If the melt viscosity is high, the resin temperature would need to be set high for extruding. However, when using the raw material having a large amount of diethylene glycol like the present invention, a high resin temperature is not preferable, since the defects in the films or the sheets after extruding film would increase. Therefore, the resin temperature is preferably 240° C. or lower, and more preferably 230° C. or lower. The lower limit of the resin temperature equals to a melting point of the raw material. However, the melting point of the raw material of the present invention may not be clear, thus the lower limit is set to 210° C. since the raw material will be melted at 210° C.

Further, it is not preferable if the melt viscosity measured at 250° C. exceeds 180 Pa·S or if the melt viscosity measured at 230° C. exceeds 350 Pa·S, since a load on a melt-extruding machine for the raw material will increase and a huge equipment will be required. The melt viscosity measured at 230° C. is preferably 330 Pa·S or less, and more preferably 310 Pa·S or less. Contrarily, it is not preferably if the melt viscosity is low, since a shear stress will be decreased at a discharge part of a molten resin and will cause an irregularity of thickness. The melt viscosity measured at 250° C. is preferably 100 Pa·S or more, and more preferably 110 Pa·S or more.

The heat-shrinkable polyester-based film of the present invention has a heat shrinkage ratio (in other words, a hot-water heat shrinkage ratio at 90° C. ) of 55% or more and 85% or less in the width direction (main shrinkage direction) of the film, which is measured by immersing the film m hot water of 90° for 10 seconds under no load, thereafter immediately immersing in water of 25° C. for 10 seconds, and calculating using lengths before and after shrinkage according to the following Equation 1.

Heat-shrink age ratio={(Length before shrinkage−Length after shrinkage)/Length before shrinkage}×100 (%) Equation 1

If the hot-water heat shrinkage ratio in the main shrinkage direction at 98° C. falls below 55%, a demand for a high shrinkable film covering the entire container (so-called “full label”) could not be met. Further, when the film is used as a label, since an amount of the shrinkage is small, strain, insufficient shrinkage, wrinkles, or slack will occur on the label after heat shrinkage. The hot-water heat shrinkage ratio at 90° C. is preferably 58% or more, and more preferably 61% or more. Since there are few demands for a film with a hot-water heat shrinkage ratio in the main shrinkage direction at 90° C. exceeding 85%, the upper limit of the hot-water heat shrinkage ratio is set to 85%.

Further, the heat-shrinkable polyester-based film of the present invention has a hot-water heat shrinkage ratio at 80° C., which is measured in the same manner as the above, in an orthogonal direction to the main shrinkage direction of the film (longitudinal direction) of −10% or more and 1% or less. It is not preferable if the hot-water heat shrinkage ratio in the orthogonal direction to the main shrinkage direction at 80° C. falls under −10%. since when used as a label for a container, an amount of a film elongation is too large due to heating, resulting in a poor shrinkage appearance. Contrarily, it is not preferable if the hot-water heat shrinkage ratio in the orthogonal direction to the main shrinkage direction at 80° C. exceeds 1%, since the heat-shrinkable label would have wrinkles or a strain like rice grains. The upper limit of the hot-water heat shrinkage ratio in the orthogonal direction to the main shrinkage direction at 80° C. is preferably 0% or less.

The heat-shrinkable polyester-based film of the present invention has a maximum shrinkage stress measured under 90° C. hot air of 2 MPa or more and 7 MPa or less in the main shrinkage direction of the film. The shrinkage stress is measured by the method described in EXAMPLES.

It is not preferable if the maximum shrinkage stress at 90° C. in the main shrinkage direction of the film exceeds 7 MPa, since shrinkage stress would cause the thin-walled container to deform during shrinkage although there is no problem with containers such as PET bottles. The maximum shrinkage stress at 90° C. is preferably 6 MPa or less, and more preferably 5 MPa or less. Contrarily, it is not preferable if the maximum shrinkage stress at 90° C. in the main shrinkage direction of the film falls under 2 MPa, since when used as a label for a container, the label would be loose and would not adhere to the container. The maximum shrinkage stress at 90° C. is preferably 2.5 MPa or more, and more preferably 3 MPa or more.

The heat-shrinkable film made from the amorphous copolymerized polyester raw material of the present invention, when the film has a thickness of 30 μm, may have a number of defects in 1 mm size or more in the longitudinal direction of the film or in the width direction of the film of 1.5 or less per 10 square meters. It is not preferable if the number of defects exceeds 1.5, since an ink would penetrate from the defects when printing, resulting in poor appearance after printing. The number of defects in the longitudinal direction of the film or in the width direction of the film per 10 square meters is preferably 1 or less, and more preferably 0.5 or less.

The heat-shrinkable polyester-based film of the present invention preferably has a difference of a hot-water heat shrinkage ratio measured by immersing the film for 10 seconds in 70° C. hot water in the main shrinkage direction of 0% or more and 5% or less between the film after being subjected to an aging treatment for 672 hours at a temperature of 30° C. and a humidity of 65% and the film before being subjected to the aging treatment (following Equation 2). It is not preferable if the difference of the hot-water heat: shrinkage ratio in 70° C. hot water before and after the aging treatment is big, since a temperature condition during a process for shrinking the film to produce a label will be different before and after the aging treatment. In particular, when the films before and after the aging treatment are mixed depending on a stock status, an appearance of shrinkage finishing properties would be different by industrially and continuously heat-shrinking the film. The difference of a hot water heat shrinkage ratio measured by immersing the film for 10 seconds in 70° C. hot water between the film after being subjected to an aging treatment and the film before being subjected to the aging treatment is preferably 4% or less, and more preferably 3% or less. The most preferable is that the hot-water heat shrinkage ratio does not change before and after the aging treatment, thus the lower limit is set to 0%.

Difference of heat-shrinkage ratio=(Hot-water heat shrinkage ratio before aging treatment−Hot-water heat shrinkage ratio after aging treatment) (%) Equation 2

The heat-shrinkable polyester-based film of the present invention preferably has an irregularity of thickness per 1 m length shown in Equation 3 of 10% or less in the longitudinal direction of the film product and in the width direction of the film product. It is not preferable if the irregularity of thickness exceeds 10%, wrinkles or meanderings will cause misregistration when the product roll is subjected to printing or processing. The irregularity of thickness is preferably 8% or less, and more preferably 6% or less.

Irregularity of thickness=(Maximum thickness−Minimum thickness)/Average thickness×100 (%) Equation 3

The thickness of the heat-shrinkable polyester-based film of the present invention is not particularly limited, and preferably 5 μm or more and 50 μm or less. The lower limit of the thickness is preferably 6 μm.

The heat-shrinkable polyester-based film of the present invention can be produced by melt-extruding the polyester raw material using an extruder to form an unstretched film, and followed by subjecting to stretching in the width direction. The polyester can be produced by conducting polycondensation of the suitable dicarboxylic acid component and the diol component as mentioned above by known methods. Further, as a raw material of the film, chip-shaped polyester may be usually used.

When the raw material resin is melt-extruded, the polyester raw material may be preferably dried using a dryer such as a hopper dryer and a paddle dryer, or a vacuum dryer. The polyester raw material is dried as described above, then melted at a temperature of 230 to 270° C. and extruded into a film by using an extruder. At the extrusion, an arbitrary conventional method such as a T-die method and a tubular method may be used.

Subsequently, the film that is molten through extrusion can be quenched to produce an unstretched film. As a method of quenching the molten resin, a method in which a molten resin is east on a rotary drum from a die to quench and solidify the cast resin to produce a substantially unoriented resin sheet may be suitably used.

For forming an arbitrary main shrinkage direction on the produced unstretched resin sheet, a lengthwise stretching or a transverse stretching may be conducted.

### (Lengthwise Stretching and Relaxation After Length Wise Stretching)

When a film is formed by lengthwise stretching, properties of the copolymerized polyester of the present invention can be more advantageously exhibited by adopting the following methods (1) and (2).

### (1) Control of Lengthwise Stretching Conditions

The transverse stretching is conducted using a speed difference between rolls. Preferably, the film is preheated to a temperature of Tg or higher and Tg+20° C. or lower on a heated roll, and an infrared heater is used to raise the temperature of the film to a temperature 5° C. to 20° C. higher than the temperature on the roll to stretch the film by 3.5 to 6 times using the speed difference. It is not preferable if the temperature of the film on the roll falls under the temperature of Tg, since the stretching stress becomes high during stretching, thereby causing breakage. It is not preferable if the temperature of the film on the roll is higher than the temperature of Tg+20° C., since the film adheres to the roll, thereby increasing the irregularity of thickness.

Further, it is preferred that the stretching temperature of the film be raised within the above range using an infrared heater or the like. This is because, in the lengthwise stretching to stretch the film between the rolls, the deformation speed during stretching becomes high due to a short stretching interval. Contrarily. in order to improve the thickness, it is preferred that a stress ratio of a stress-strain curve (tensile stress at the time of final stretching/stress at upper yield point) be high. Therefore, when the stretching temperature is high, the stress at upper yield point becomes low, and this is preferable since the stress ratio of the stress-strain curve can be controlled within an appropriate range.

### (2) Relaxation in Longitudinal Direction After Lengthwise Stretching

After lengthwise stretching, a film is desirably subjected to a beat treatment and relaxation in the longitudinal direction (0% is without relaxation). The shrinkage ratio in the longitudinal direction is slightly reduced by relaxation, but the molecular orientation is relaxed in the longitudinal direction, so that the shrinkage stress can be reduced. Furthermore, the molecular orientation is relaxed by conducting a heat treatment at a temperature higher than the stretching temperature, so that the shrinkage stress can be reduced. As for a heat treatment method, for example, a heated furnace may be used or the roll temperature after MD stretching may be raised to beat the film.

### (Transverse Stretching and Relaxation After Transverse Stretching)

When a film is formed by transverse stretching, properties of the copolymerized polyester of the present invention can be more advantageously exhibited by adopting the following methods (3) and (4),

### (3) Control of Transverse Stretching Conditions

The transverse stretching is conducted preferably such that the film is preheated to a temperature of Tg+10° or higher and Tg+25° C. or lower in a state where both edges in the width direction of the film are held by clips in a tenter, and then, the film is stretched by 3.5 to 6 times in the width direction while cooling the film to a temperature of Tg or higher and Tg+9° C. or lower. By stretching the film in the width direction while cooling, a stress ratio of a stress strain curve (tensile stress at the time of final stretching/stress at upper yield point) becomes high, and the irregularity of thickness in the width direction con be reduced. After the transverse stretching, it is preferred to conduct a heat treatment at a temperature of the stretching temperature+1° C. to the stretching temperature+10° C. It is not preferable if the heat treatment temperature is lower than the stretching temperature, since the molecular orientation is not sufficiently relaxed, so that the shrinkage stress cannot be reduced. Further, it is not preferable if the heat treatment temperature is higher than the stretching temperatures+10° C., since the shrinkage ratio in the width direction may decrease.

### (4) Relaxation in the Width Direction After Transverse Stretching

In a heat treatment step, it is preferable to relax a film by 0% to 5% in the width direction in a state where both edges in the width direction of the film are held by clips in a tenter (0% is without relaxation). A shrinkage ratio in the width direction is slightly reduced by relaxation, but the molecular orientation is relaxed in the width direction, so that the shrinkage stress can be reduced. Furthermore, in a final heat treatment step, the film is subjected to a heat treatment at a temperature higher than the stretching temperature, whereby the molecular orientation is relaxed, and the shrinkage stress can be reduced.

The packaging bag of the present invention is produced by covering at least a part of a periphery of an object for packaging with a label having perforations or notches prepared from the heat-shrinkable polyester-based film of the present invention, followed by subjecting to a heat-shrinking treatment. Examples of the object, for packaging include PET bottles for beverages, various kinds of bottles, cans, plastic containers for confectionary, a box lunch and the like, paper-made boxes, and the like. In general, when the object for packaging is covered by heat-shrinking of the label prepared from the heat-shrinkable polyester based film, the label is heat-shrunk by about 5 to 70% to be closely adhered to the packaging bag. The label for covering the object for packaging may be printed or may not be printed.

A method for producing a label from the heat-shrinkable polyester-based film of the present invention is as follows; an organic solvent is applied on the inside slightly from the end part of one surface of a rectangular film, and the film is immediately rounded to stack and bond the end parts and formed into a label, or an organic solvent is applied on the inside slightly from the end part of one surface of a film wound as a roll, the film is immediately rounded to stack and bond the end parts and form into a tube, and the tube-formed film is cut into a label. As the organic solvent for bonding, cyclic ethers such as 1,3-dioxolan and tetrahydrofuran are preferable. Besides, there may be used aromatic hydrocarbons such as benzene, toluene, xylene and trimethylbenzene; halogenated hydrocarbons such as methylene chloride and chloroform; phenols such as phenol, or a mixture thereof.

### EXAMPLES

Next, the present invention will be specifically described with reference to Examples and Comparative examples but the present invention is not limited to the aspects of the Examples at all, and can be appropriately modified within the scope not departing from the gist of the present invention. The evaluation method of the films is shown below.

### [Heat-Shrinkage Ratio (Hot-Water Heat Shrinkage Ratio)]

Film was cut to give a 10 cm×10 cm square sample. The square sample was immersed in hot water of a predetermined temperature (° C.)±0.5° C. for 10 seconds under no load inducing heat shrinkage, thereafter in water of 25° C.±0.5° C. for 10 seconds, and then taken out from water. Subsequently, a size of the sample in the longitudinal direction and in the width direction was determined, and the heat-shrinkage ratio was calculated according to the following Equation 1.

Heat-shrinkage ratio={(Length before shrinkage−Length after shrinkage)/Length before shrinkage}×100 (%) Equation 1

### [Difference of Heat-Shrinkage Ratio Before and After Aging Treatment]

Hot-water heat shrinkage ratio shrinkage ratio at 70° C. was calculated in the same manner as in the Equation 1. Subsequently, an unmeasured film was subjected to an aging treatment in an environmental test lab at 30° C. and a relative humidity of 65% for 672 hours, and thereafter a hot-water heat shrinkage ratio shrinkage ratio at 70° C. of the film was also calculated. Difference of heat-shrinkage ratio was calculated according to the following Equation 2 respectively.

Difference of heat-shrinkage ratio=(hot-water heat shrinkage ratio before aging treatment−Hot-water heat shrinkage ratio after aging treatment) (%) Equation 2

### [Shrinkage Stress]

A rectangular sample having a length of 200 mm in a main shrinkage direction (width direction) and a width of 20 mm was cut our from a heat-shrinkable film, and a shrinkage stress was measured using a strength and elongation measuring machine with a heating furnace manufactured by Toyo Baldwin Co., Ltd. (current company name ORIENTEC Co., Ltd.; TENSILON universal testing machine PTM-250, registered trademark of ORIENTEC Co., Ltd.). The heating furnace of the strength and elongation measuring machine was previously heated to 90° C., and the distance between chucks for holding the sample was set to 100 mm. When the sample is attached to the chucks of the strength and elongation measuring machine, the ventilation to the heating furnace was temporarily stopped, and the door of the heating furnace was opened. The position of 25 mm from the both edges of the sample with a length of 150 mm was held by the chucks, and the distance between the chucks was set to 100 mm. The sample was fixed without looseness so that the distance between the chucks and the length direction of the sample were aligned and the sample was horizontal. After attaching the sample to the chucks, the doors of the heating furnace were quickly closed, followed by resuming the ventilation. The time when closing the doors of the heating furnace and resuming the ventilation was determined as the time when the measurement of the shrinkage stress was started. The maximum value after the measurement for 30 seconds was determined as a shrinkage stress (MPa).

### [Irregularity of Thickness]

The film was cut to give a rectangular sample with a size of 1 m in the desired direction×40 mm in the width direction. Using a continuous contact type thickness gauge manufactured by Mikuron Measuring Instrument Co., Ltd., the thickness was continuously measured at a measuring speed of 5 m/min along the longitudinal direction of the sample. Irregularity of thickness of the film was calculated according to the following Equation 3.

Irregularity of thickness=(Maximum thickness−Minimum thickness)/Average thickness×100 (%) Equation 3

### [Intrinsic Viscosity]

The polyester (0.2 g) was dissolved in a mixed solvent of phenol/1,1,2,2-tetrachloroethane (50 ml, 60/40 (weight ratio)), and the intrinsic viscosity was measured at 30° C. using an Ostwald viscometer. The unit was dl/g.

### [Melt Viscosity]

Using a Capillograph 1D PMD-C manufactured by Toyo Seiki Seisaku-sho. Ltd., the resin was set to a predetermined temperature (250° C., 230° C. ), and melt viscosity was measured according to JIS K7199 at a shear rate of 6080/S.

### [How to Count the Number of Defects]

The film was cut to give a sample with a size of 50 cm in the width direction and 50 cm in the longitudinal direction. The cut film was placed on a desktop-type film orientation viewer (manufactured by Unitika Ltd.) and polarized. Alter that, the number of defects in 1 mm sup or more was counted using a magnifying glass with a magnification of 10 times. In the same way, the number of defects in a total 120 films (per 30 square meters). Then, the number of defects was determined on an average per 10 square meters according to the following Equation 4.

Number of defects on an average=Number of all defects/3 (defects/per 10 square meters) Equation 4

### [Content of Amorphous Unit]

A heat-shrinkable film was scraped off with a razor blade and sampled. The sampled film (about 5 mg) was dissolved in 0.7 ml of a mixed solution of deuterated chloroform and trifluoroacetic acid (in a volume ratio of 9/1). The amount of amorphous units (in the following examples, neopentyl glycol unit and cyclohexanedimethanol unit) was calculated using 1H-NMR (UNITY50 manufactured by Varian), and the mol % thereof (the sum of a ratio of polyol-type amorphous unit when the polyol unit is taken as 100 mol % and a ratio of the polycarboxylic acid-type amorphous unit when the polycarboxylic acid unit is taken as 100 mol %) was determined. A product of the amount (mass %) of polymers in the film and the mol % above was defined as a content of the amorphous units (mol % by mass).

### [Tg (Glass Transition Temperature)]

Using a differential scanning calorimeter (model: DSC220: manufactured by Seiko Instruments Inc.), an unstretched film (5 mg) was heated from −40° C. to 120° C. at a heating rate of 10° C./min. The glass transition temperature was determined from the resulting endothermic curve. Specifically, the temperature of an intersection of an extended line of a base line being lower than the glass transition temperature and a tangent showing a maximum inclination in a transition part was defined as a glass transition temperature (Tg).

### [Shrinkage Finishing Properties]

A heat-shrinkable film was previously subjected to a three-color printing with inks in green, gold and white colors manufactured by Toyo Ink Co., Ltd. Both ends of the printed film were bonded to each other using dioxolane to prepare a cylindrical-shaped label fa label in which the main shrinkage direction of the heat-shrinkable film was a circumferential direction), and the label was cut. The diameter of the label in the shrinkage direction was 70 mm. Thereafter, the label was put on a 500 ml PET bottle (trunk diameter: 62 mm, minimum diameter of neck part: 25 mm) and subjected to a heat-shrinking treatment at a zone temperature of 90° C. with a passing time of 5 seconds using a steam tunnel (model-SH-1500-L manufactured by Fuji Astec Inc.) to mount the label to the bottle. At the time of mounting, the position of a part with a diameter of 30 mm in the neck part was adjusted so as to be at one end of the label. The finishing properties after shrinking were visually evaluated. Criteria for evaluation were as follows.

### [Shrinkage Strain of Label]

For evaluating finishing properties after shrinkage, strain in the direction of 360 degrees at the upper part of the mounted label was measured using a gauge and the maximum value of the strain was determined. This shrinkage strain of the label was evaluated according to the following criteria. ◯: maximum strain less than 1.5 mm χ: maximum strain 1.5 mm or more

### [Insufficient Shrinkage of Label]

The above shrinkage state of the label was evaluated according to the following criteria. ◯: The label was shrunk with no slack between the mounted label and rite container. χ: There was a slack between the label and the container due to insufficient shrinkage.

### [Wrinkles of Label]

Under the same conditions as those for the shrinkage strain of the label mentioned above, the occurrence state of wrinkles was evaluated according to the following criteria. ◯: 2 or less wrinkles with a size of 1.5 mm or more χ: 3 or more wrinkles with a size of 1.5 mm or more

### [Shrinkage Finishing Properties After Aging Treatment]

A heat-shrinkable film after being subjected to an aging treatment for 672 hours at 30° C. and a humidity of 65% was previously subjected to a three-color printing with inks in green, gold and white colors manufactured by Toyo Ink Co., Ltd. Both ends of the printed film were bonded to each other using dioxolane to prepare a cylindrical-shaped label (a label in which the main shrinkage direction of the heat-shrinkable film was a circumferential direction), and the label was cut. The diameter of the label in the shrinkage direction was 70 mm. Thereafter, the label was put on a 500 ml PET bottle (trunk diameter: 62 mm, minimum diameter of neck part: 25 mm) and subjected to a heat-shrinking treatment at a zone temperature of 90° C. with a passing time of 5 seconds using a .steam tunnel (model-SH-1500-L manufactured by Fuji Astec Inc.) to mount the lube) to the bottle. At the time of mounting, the position of a part with a diameter of 30 mm in the neck part was adjusted so as to be at one end of the label. The finishing properties after shrinking were visually evaluated. Criteria for evaluation were as follows.

The finishing properties were evaluated in the same manner as in the above-mentioned “Shrinkage strain of label”. “Insufficient shrinkage of label”, and “Wrinkles of label”.

<Preparation of Polyester Raw Materials>

Raw materials A to H were produced by a known method of a polycondensation through a transesterification using a dimethyl terephthalate (DMT) and each glycol component described below.

Raw material A: a polyester made from neopentyl glycol 25 mol %. diethylene glycol 12 mol %, ethylene glycol 63 mol % and terephthalic acid. intrinsic viscosity: 0.60 dl/g.

Raw material B: a polyester made from neopentyl glycol 30 mol %, diethylene glycol 8 mol %, ethylene glycol 62 mol % and terephthalic acid. intrinsic viscosity: 0.60 dl/g.

Raw material C: a polyester made from neopentyl glycol 18 mol %, diethylene glycol 15 mol %, ethylene glycol 67 mol % and terephthalic acid. intrinsic viscosity: 0.65 dl/g.

Raw material C: a polyester made from neopentyl glycol 25 mol %, diethylene glycol 5 mol %, ethylene glycol 70 mol % and terephthalic acid. intrinsic viscosity: 0.65 dl/g.

Raw material E: a polyester made from neopentyl glycol 11 mol %, diethylene glycol 12 mol % ethylene glycol 77 mol % and terephthalic acid. intrinsic viscosity: 0.05 dl/g.

Raw material F: a polyester made from neopentyl glycol 18 mol %, diethylene glycol 15 mol %, ethylene glycol 67 mol % and terephthalic acid, intrinsic viscosity: 0.85 dl/g.

In the production of the above polyesters. SiO₂ (Silysia 266 manufactured by Fuji Silysia Chemical Ltd.) was added as a lubricant in a proportion of 600 ppm relative to the polyesters. In the following Tables, EG represents ethylene glycol, DEG represents diethylene glycol, and NPG represents neopentyl glycol. Each polyester was appropriately formed into a chip shape.

Table 1 and Table 2 show a composition of the polyester raw material used in Examples and Comparative Examples, and a resin composition and a manufacturing condition of the film in Examples and Comparative Examples, respectively.

TABLE 1

| | Dicarboxylic | | | | Added | | | | |
|---|---|---|---|---|---|---|---|---|---|
| | acid | Polyol | | | amount | | | 250° C. | 230° C. |
| | components | components | | | of | | Intrinsic | Melt | Melt |
| | (mol %) | (mol %) | | | lubricant | Tg | viscosity | viscosity | viscosity |
| | DMT | EG | DEG | NPG | (ppm) | (° C.) | (dl/g) | (Pa · S) | (Pa · S) |
| Raw material A | 100 | 63 | 12 | 25 | 600 | 68 | 0.69 | 140 | 270 |
| Raw material B | 100 | 62 | 8 | 30 | 600 | 69 | 0.60 | 120 | 210 |
| Raw material C | 100 | 67 | 15 | 18 | 600 | 67 | 0.65 | 130 | 240 |
| Raw material D | 100 | 70 | 5 | 25 | 600 | 71 | 0.65 | 135 | 260 |
| Raw material E | 100 | 77 | 12 | 11 | 600 | 68 | 0.65 | 130 | 245 |
| Raw material F | 100 | 67 | 15 | 18 | 600 | 67 | 0.85 | 200 | 400 |

TABLE 2

| | | | Lengthwise stretching | | | | | | | | | |
|---|---|---|---|---|---|---|---|---|---|---|---|---|
| | | | | | | | Relax- | Transverse stretching | | | | |
| | | | Temper- | Film | | Temper- | ation | | | | | Relax- |
| | | Resin | ature | temper- | | ature | ratio | Temper- | Temper- | | Heat | ation |
| | | temper- | of | ature | | of the | in the | ature | ature | | treat- | ratio |
| | | ature | pre- | during | | roll | longi- | during | during | | ment | in the |
| | Used | in | heated | stretch- | | after | tudinal | pre- | stretch- | | temper- | width |
| | raw | extruder | roll | ing | Stretch | stretching | direction | heating | ing | Stretch | ature | direction |
| | material | (° C.) | (° C.) | (° C.) | ratio | (° C.) | (%) | (° C.) | (° C.) | ratio | (° C.) | (%) |
| Example 1 | A | 230 | 75 | 90 | 5 | 80 | 3 | Not performed | | | | |
| Example 2 | B | 230 | 76 | 91 | 5 | 81 | 3 | Not performed | | | | |
| Example 3 | C | 230 | 74 | 89 | 5 | 79 | 3 | Not performed | | | | |
| Example 4 | A | 230 | Not performed | | | | | 90 | 78 | 5 | 84 | 3 |
| Example 5 | B | 230 | Not performed | | | | | 91 | 79 | 5 | 85 | 3 |
| Example 6 | C | 230 | Not performed | | | | | 89 | 77 | 5 | 83 | 3 |
| Comparative | D | 230 | 78 | 93 | 5 | 83 | 3 | Not performed | | | | |
| Example 1 | | | | | | | | | | | | |
| Comparative | E | 230 | 75 | 90 | 5 | 80 | 3 | Not performed | | | | |
| Example 2 | | | | | | | | | | | | |
| Comparative | F | 270 | 74 | 89 | 5 | 79 | 3 | Not performed | | | | |
| Example 3 | | | | | | | | | | | | |

### Example 1

The raw material A was charged into an extruder. This resin was melted at 270° C., extruded from a T die while cooling the resin to 230° C., and quenched by winding around a rotating metal roll set at a surface temperature of 25° C. to produce an unstretched film with a thickness of 146 μm. The take-off speed (rotation speed of the metal roll) of the unstretched film at this time was about 20 m/min. Tg of the unstretched film was 68° C. The produced unstretched film was introduced to a lengthwise drawing machine, preheated with a roll having a surface temperature of Tg+7° C. and stretched by 5 times at a film temperature of Tg+22° C. using an infrared heater. The film after lengthwise stretching was introduced to heating rolls having a surface temperature of Tg+12° C. after stretching, and relaxed by 3% in the longitudinal direction using the speed difference between the rolls. The relaxed film was cooled with a cooling roll having a surface temperature of Tg−40° C. Afterward, both edge parts of the film were cut and removed so that the width of the film became 500 mm, and the film was wound into a roll, whereby a lengthwise uniaxially-oriented film with a thickness of 30 μm was continuously produced in a proscribed length. The film was evaluated for various characteristics in the above-mentioned manner The evaluation results are shown in Table 3. The film had little changes in physical properties before and after the aging treatment and thus exhibited favorable results.

### Example 2

A film with a thickness of 30 μm was produced in the same manner as in Example 1, except that the raw material A was changed to the raw material B. Tg of the film was 69° C. The evaluation results are shown in Table 3. The film exhibited favorable results similar to those of Example 1.

### Example 3

A film with a thickness of 30 μm was produced in the same manner as in Example 1, except that the raw material A was changed to the raw material C. Tg of the film was 67° C. The evaluation results are shown in Table 3. The film exhibited favorable results similar to those of Example 1.

### Example 4

The raw material A was charged into an extruder. This resin was melted at 270° C., extruded from a T die while cooling the resin to 230° C., and quenched by winding around a rotating metal roll set at a surface temperature of 25° C. to produce an unstretched film with a thickness of 146 μm. The take-off speed (rotation speed of the metal roll) of the unstretched film at this time was about 20 m/min. Tg of the unstretched film was 68° C. The produced unstretched film was introduced to a tenter, preheated so that a film temperature was Tg+17° C. Thereafter, the film was stretched by 5 times in the width direction while cooling the film to a surface temperature of Tg+5° C. After that, the film was relaxed by 3% in the width direction while being heated so that a surface temperature of the film was Tg+11° C. Afterward, the relaxed film was cooled. Both edge parts of the film were cut and removed so that the width of the film became 1000 mm, and the film was wound into a roll, whereby an uniaxially-oriented film with a thickness of 30 μm was continuously produced in a prescribed length. The film was evaluated for various characteristics in the above-mentioned manner. The evaluation results are shown in Table 3. The film had little changes in physical properties before and after the aging treatment and thus exhibited favorable results.

### Example 5

A film with a thickness of 30 μm was produced in the same manner as in Example 4, except that the raw material A was changed to the raw material B. Tg of the film was 69° C. The evaluation results are shown in Table 3. The film exhibited favorable results similar to those of Example 4.

### Example 6

A film with a thickness of 30 μm was produced in the same manner as in Example 1, except that the raw material A was changed to the raw material C. Tg of the film was 67° C. The evaluation results are shown in Table 3. The film exhibited favorable results similar to those of Example 4.

### Comparative Example 1

A film with a thickness of 30 μm was produced in the same manner as in Example 1, except that the raw material A was changed to the raw material D. The evaluation results are shown in Table 3. Compared to Example 1, the shrinkage finishing properties before the aging treatment was good, however, the shrinkage ratio at 70° C. in the longitudinal direction after the aging treatment was low (a decrease due to the aging treatment was large). Thus, the shrinkage finishing properties were bad when the shrinkage finishing was performed under the same condition as before the aging treatment.

### Comparative Example 2

A film with a thickness of 30 μm was produced in the same manner as in Example 1, except that the raw material A was changed to the raw material E. The evaluation results are shown in Table 3. Compared to Example 1, the shrinkage ratio at 90° C. in the longitudinal direction was low, and the shrinkage finishing properties were bad.

### Comparative Example 3

The raw material A was changed to the raw material F. Further, the raw material was melted and extruded at 270° C. This is because, due to the high intrinsic viscosity of the raw material, if a temperature in an extruding step was low, a load on an extruding machine increased and extrusion became difficult. A film with a thickness of 30 μm was produced in the same manner as in Example 3 except for them. The evaluation results are shown in Table 3. Compared to Example 3, the shrinkage stress was high, and the shrinkage finishing properties were bad. Additionally, there were a lot of defects.

TABLE 3

| | Before aging areatment | | | | | | | | | | | |
|---|---|---|---|---|---|---|---|---|---|---|---|---|
| | | | | | | | Irreg- | | | | | |
| | | | | | | Shrink- | ularity | Irreg- | | | | |
| | | | | | | age | of | ularity | | | | Number |
| | | | | | | stress | thick- | of | | | | of |
| | | | Shrinkage ratio (%) | | | in the | ness | thick- | | | | defects |
| | | | 70° C. | 80° C. | 90° C. | main | in the | ness | | Insuffi- | | in 1 mm |
| | Film | | Main | Non- | Main | shrink- | long- | in the | Shrink- | cient | | size |
| | intrinsic | Thick- | shrink- | shrink- | shrink- | age | itudinal | width | age | shrink- | | or more |
| | viscosity | ness | age | ing | age | direction | direction | direction | strain | age | Wrinkles | (defects/ |
| | (dl/g) | (μm) | direction | direction | direction | (MPa) | (%) | (%) | of label | of label | of label | (10 m²) |
| Example 1 | 0.66 | 30 | 45 | −3 | 75 | 4.4 | 4 | 5 | ∘ | ∘ | ∘ | 0.3 |
| Example 2 | 0.57 | 30 | 39 | −2 | 80 | 5 | 4 | 5 | ∘ | ∘ | ∘ | 0.3 |
| Example 3 | 0.62 | 30 | 47 | −4 | 65 | 3.9 | 5 | 5 | ∘ | ∘ | ∘ | 0.7 |
| Example 4 | 0.66 | 30 | 35 | −7 | 80 | 4.1 | 5 | 4 | ∘ | ∘ | ∘ | 0.3 |
| Example 5 | 0.57 | 30 | 33 | −5 | 80 | 3.9 | 4 | 3 | ∘ | ∘ | ∘ | 0.3 |
| Example 6 | 0.62 | 30 | 36 | −8 | 79 | 3 | 5 | 3 | ∘ | ∘ | ∘ | 0.3 |
| Comparative | 0.62 | 30 | 28 | 1 | 75 | 6.5 | 3 | 4 | ∘ | ∘ | ∘ | 0.3 |
| Example 1 | | | | | | | | | | | | |
| Comparative | 0.62 | 30 | 30 | −4 | 54 | 3.7 | 4 | 4 | — | x | — | 0.7 |
| Example 2 | | | | | | | | | | | | |
| Comparative | 0.78 | 30 | 50 | −1 | 69 | 7.3 | 3 | 3 | ∘ | ∘ | x | 2.4 |
| Example 3 | | | | | | | | | | | | |

| | | | | | | | Difference before and | | |
|---|---|---|---|---|---|---|---|---|---|
| | After aging areatment | | | | | | after aging treatment | | |
| | Shrinkage ratio (%) | | | | | | Shrinkage ratio (%) | | |
| | 70° C. | 80° C. | 90° C. | | Insuffi- | | 70° C. | 80° C. | 90° C. |
| | Main | Non- | Main | Shrink- | cient | | Main | Non- | Main |
| | shrink- | shrink- | shrink- | age | shrink- | | shrink- | shrink- | shrink- |
| | age | ing | age | strain | age | Wrinkles | age | ing | age |
| | direction | direction | direction | of label | of label | of label | direction | direction | direction |
| Example 1 | 43 | −5 | 75 | ∘ | ∘ | ∘ | 2 | 0 | 0 |
| Example 2 | 34 | −4 | 81 | ∘ | ∘ | ∘ | 5 | 0 | 0 |
| Example 3 | 47 | −6 | 65 | ∘ | ∘ | ∘ | 0 | 0 | 0 |
| Example 4 | 31 | −7 | 80 | ∘ | ∘ | ∘ | 4 | 0 | 0 |
| Example 5 | 31 | −5 | 80 | ∘ | ∘ | ∘ | 2 | 0 | 0 |
| Example 6 | 36 | −8 | 79 | ∘ | ∘ | ∘ | 0 | 0 | 0 |
| Comparative | 11 | 1 | 75 | x | ∘ | x | 17 | 0 | 0 |
| Example 1 | | | | | | | | | |
| Comparative | 30 | −4 | 54 | — | [symbol] | — | 0 | 0 | 0 |
| Example 2 | | | | | | | | | |
| Comparative | 49 | 1 | 69 | ∘ | ∘ | x | 1 | 0 | 0 |
| Example 3 | | | | | | | | | |

[symbol]

indicates data missing or illegible when filed

### INDUSTRIAL APPLICABILITY

The heat-shrinkable polyester-based film of the present invention not only has a high heat-shrinkage ratio, tut also has a small decrease in the heat-shrinkage ratio after an aging treatment and a small number of defects. Thus, the film can be suitably used for a label application. A packaging bag such as containers produced by the label comprising the heat-shrinkable polyester-based film of the present invention has a beautiful appearance. Further, the copolymerized polyester raw material of the present invention for amorphous films can be preferably used for producing the heat-shrinkable polyester-based film.

1. An amorphous copolymerized polyester raw material for a film, wherein the polyester raw material satisfies the following requirements (1) to (4):
(1) the copolymerized polyester raw material contains ethylene terephthalate as a main constituent component, and comprises neopentyl glycol by 15 mol % or more and 30 mol % or less when a total amount of glycol component in a total polyester resin component is taken as 100 mol %,
(2) the copolymerized polyester raw material comprises a constituent unit derived from diethylene glycol by 7 mol % or more and 15 mol % or less in the total amount of glycol component 100 mol % in the total polyester resin component.
(3) the copolymerized polyester raw material has an intrinsic viscosity of 0.60 dl/g or more and less than 0 70 dl/g, and
(4) the copolymerized polyester raw material has a glass transition temperature of 60° C. or higher and 70° C. or lower

2. The copolymerized polyester raw material for a film according to claim 1, wherein when the copolymerized polyester raw material is made into a film having a thickness of 30 μm, a number of defects in 1 mm size or more in the longitudinal direction of the film or in the width direction of the film is 1.5 or less on an average per 10 square meters of the film.

3. The copolymerized polyester raw material for a film according to claim 1, wherein the copolymerized polyester raw material has a melt viscosity of 180 Pa·S or less measured at a shear rate of 6080/S at 250° C. and a melt viscosity of 350 Pa·S or less measured at a shear rate of 6080/S at 230° C.

4. A heat-shrinkable polyester-based film, wherein the heat-shrinkable polyester-based film comprises the amorphous copolymerized polyester raw material according to claim 1, and satisfies the following requirements (1) to (5):
(1) intrinsic viscosity is 0.57 dl/g or more and 0.67 dl/g or less,
(2) a hot-water heat shrinkage ratio measured by immersing the film for 10 seconds in 90° C. hot water is 55% or more and 85% or less in a main shrinkage direction of the film.
(3) a hot-water heat shrinkage ratio measured by immersing the film for 10 seconds in 80° C. hot water is −10% or more and 1% or less in an orthogonal direction to the main shrinkage direction of the film.
(4) a maximum shrinkage stress measured under 90° C. hot air is 2 MPa or more and 7 MPa or less in the main shrinkage direction of the film,
(5) a difference of a hot-water heat shrinkage ratio measured by immersing the film for 10 seconds in 70° C. hot water in the main shrinkage direction of the film is 0% or more and 5% or less between the film after being subjected to an aging treatment for 672 hours at 30° C. and a relative humidity of 65% and the film before being subjected to the aging treatment

5. The heat-shrinkable polyester-based film according to claim 4, wherein an irregularity of thickness per 1 m length is 10% or less both in the longitudinal direction of the film and in the width direction of the film

6. A heat-shrinkable label, comprising the heat-shrinkable polyester-based film according to claim 4.

7. A packaging bag, wherein the packaging bag is produced by covering at least a pan of a periphery of an object for packaging with the heat-shrinkable label according to claim 6, and followed by subjecting to a heat-shrinking treatment

8. A heat-shrinkable label, comprising the heat-shrinkable polyester-based film according to claim 5.

9. A packaging bag, wherein the packaging bag is produced by covering at least a part of a periphery of an object for packaging with the heat-shrinkable label according to claim 8, and followed by subjecting to a heat-shrinking treatment.

10. The copolymerized polyester raw material for a film according to claim 2, wherein the copolymerized polyester raw material has a melt viscosity of 180 Pa·S or less measured at a shear rate of 6080/S at 250° C., and a melt viscosity of 350 Pa·S or less measured at a shear rate of 6080/S at 230° C.

11. A heat-shrinkable polyester-based film, wherein the heat-shrinkable polyester-based film comprises the amorphous copolymerized polyester raw material according to claim 10, and satisfies the following requirements (1) to (5):
(1) intrinsic viscosity is 0.57 dl/g or more and 0.67 dl/g or less,
(2) a hot-water heat shrinkage ratio measured by immersing the film for 10 seconds in 90° C. hot water is 55% or more and 85% or less in a main shrinkage direction of the film,
(3) a hot-water heat shrinkage ratio measured by immersing the film for 10 seconds in 80° C. hot water is −10% or more and 1% or less in an orthogonal direction to the main shrinkage direction of the film,
(4) a maximum shrinkage stress measured under 90° C. hot air is 2 MPa or more and 7 MPa or less in the main shrinkage direction of the film,
(5) a difference of a hot-water heat shrinkage ratio measured by immersing the film for 10 seconds in 70° C. hot water in the main shrinkage direction of the film is 0% or more and 5% or less between the film after being subjected to an aging treatment for 672 hours at 30° C. and a relative humidity of 65% and the film before being subjected to the aging treatment

12. The heat-shrinkable polyester-based film according to claim 11, wherein an irregularity of thickness per 1 m length is 10% or less both in the longitudinal direction of the film and in the width direction of the film

13. A heat-shrinkable label, comprising the heat-shrinkable polyester-based film according to claim 11.

14. A packaging bag, wherein the packaging bag is produced by covering at least a pan of a periphery of an object for packaging with the heat-shrinkable label according to claim 13, and followed by subjecting to a heat-shrinking treatment.

15. A heat-shrinkable label, comprising the heat-shrinkable polyester-based film according to claim 12.

16. A packaging bag, wherein the packaging bag is produced by covering at least a part of a periphery of an object for packaging with the heat-shrinkable label according to claim 15, and followed by subjecting to a heat-shrinking treatment.
